(19) United States
(12) Patent Application Publication
(10) Pub. No.: US 2013/0344466 A1
(43) Pub. Date: Dec. 26, 2013

(54) AUGMENTATIVE AND ALTERNATIVE COMMUNICATION DEVICE FOR A DISABLED PERSON

(71) Applicants: Ju Hye Yook, Seoul (KR); Hyun Jung Oh, Gyeonggi-do (KR); Pyoung Ho Lee, Seoul (KR); Ha Nule Go, Seoul (KR); Jong Hoon Bae, Gyeonggi-do (KR)

(72) Inventors: Ju Hye Yook, Seoul (KR); Hyun Jung Oh, Gyeonggi-do (KR); Pyoung Ho Lee, Seoul (KR); Ha Nule Go, Seoul (KR); Jong Hoon Bae, Gyeonggi-do (KR)

(73) Assignee: Korea Nazarene University Industry-Academic Corporation Foundation, Chungcheongnam-do (KR)

(21) Appl. No.: 14/003,185

(22) PCT Filed: Mar. 12, 2012
(86) PCT No.: PCT/KR2012/001772

§ 371 Date: Sep. 4, 2013

(30) Foreign Application Priority Data
Mar. 10, 2011 (KR) 10-2011-0021333

(51) Int. Cl. G09B 19/00

(52) U.S. Cl. CPC G09B 19/00
USPC 434/236

(57) ABSTRACT

An augmentative and alternative communication (AAC) device for a disabled person, and more particularly, an AAC device for the disabled person who has some degree of cognitive skills using pictures to express his/her communication. The AAC device includes a main body having a board shape in which an indicator connector protrudes from a front center portion; a communication display board attached to a front surface of the main body and including a plurality of symbols attached in a radial shape; an indicator rotatably connected to the indicator connector to indicate the corresponding symbols according to a user indication; and a controller installed in a lower portion of the main body, receiving an input signal from the user, and controlling the operation of the indicator.

### CROSS REFERENCE TO RELATED APPLICATIONS AND CLAIM OF PRIORITY

This patent application is a National Phase application under 35 U.S.C. §371 of International Application No. PCT/KR2012/001471, filed Feb. 27, 2012, which claims priority to Korean Patent Application No. 10-2011-0016983 filed Feb. 25, 2011, entire contents of which are incorporated herein by reference.

### BACKGROUND OF THE INVENTION

1. Field of the Invention

The present invention relates to an augmentative and alternative communication (AAC) device for a disabled person, and more particularly, to an AAC device for a disabled person who has some degree of cognitive skill using pictures to express his/her communication.

2. Description of the Related Art

In general, augmentative and alternative communication (AAC) means all communication methods used by individuals in speech, vocalizations, gestures, communication actions, specific communication methods or tools.

AAC is used by those with a wide range of congenital impairments such as intellectual impairment, developmental delay, cerebral palsy, autism, developmental verbal dyspraxia, specific language disability, learning disability, and acquired conditions such as brain injury, spinal injury, aphasia, and Parkinson's disease.

In particular, an AAC system is underdeveloped in Korea, and very few people are conducting research into AAC. Thus, many people think that it is difficult to effectively provide an AAC service. This may be caused by difficulty in purchasing equipment and associated warranties for using the equipment, lack of experts, and lack of general understanding of AAC.

Korea depends on the import of 90% of assistive technology devices like AAC related devices that are currently used in Korea. Although those devices are imported, it is impossible to use some of them in Korea due to language barriers. In particular, devices with LCDs use foreign languages, and their use is nearly impossible.

In addition, the purchase unit price of transport boards (E-tran boards), voice combined communication tools, and ACC devices (i.e., software) are doubled due to foreign exchange rates and distribution processes, and Korea does not provide subsidized support, leaving individuals with the economic burden of purchasing them.

### SUMMARY OF THE INVENTION

The present invention provides an augmentative and alternative communication (AAC) device for a disabled person, in which the AAC device is configured to allow the other party to express his/her communication by being cognitive for symbols whereby various pictures are associated therewith and selection of the symbols using the AAC device may be more inexpensive than systematized devices. The AAC device may also enhance the physical abilities, cognitive skills, linguistic abilities, and learning abilities of disabled persons by increasing their convenience for use and accessibility of the AAC device.

According to an aspect of the present invention, provided is an AAC device for a disabled person, the AAC device including: a main body having a board shape in which an indicator connector protrudes from a front center portion; a communication display board attached to a front surface of the main body and including a plurality symbols attached in a radial shape; an indicator rotatably connected to the indicator connector to indicate the corresponding symbols according to a user indication; and a controller installed in a lower portion of the main body, receiving an input signal from the user, and controlling the operation of the indicator.

The communication display board may include a transparent blank in the remaining portions excluding a portion to which the plurality of symbols are attached.

Targets of the plurality of symbols may include one of several places, things, activities, quantities, foods, persons, times, and characters.

The controller may include: a motor for rotating clockwise and counter-clockwise to revolve the indicator; a motor driver applying a driving signal to the motor to drive the motor; an input switch inputting a signal for driving the motor; and a battery supplying power to the motor driver.

The input switch may include: a jack connected to the motor driver; a signal controller connected to the jack to detect a user click signal and control the click signal; a button detecting a user click motion and delivering the click motion to the signal controller; and a pad to which the signal controller and the button are fixedly attached.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an augmentative and alternative communication (AAC) device for a disabled person according to an embodiment of the present invention;

FIG. 2 is a perspective view with separate parts of the AAC for a disabled person according to an embodiment of the present invention;

FIG. 3 is a structural view of a controller of the AAC for a disabled person according to an embodiment of the present invention; and

FIG. 4 is a structural view of an input switch of the AAC for a disabled person according to an embodiment of the present invention.

### DETAILED DESCRIPTION

The present invention will now be more fully described with reference to the accompanying drawings, in which exemplary embodiments of the present invention are shown.

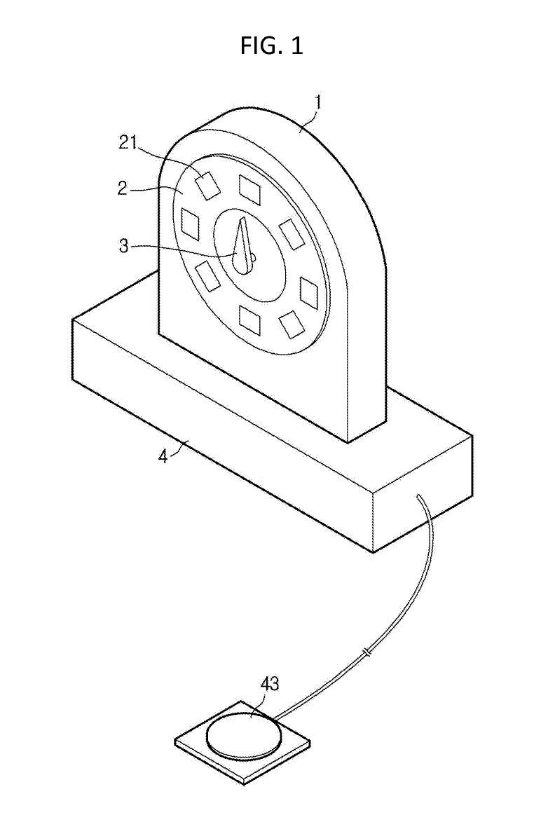

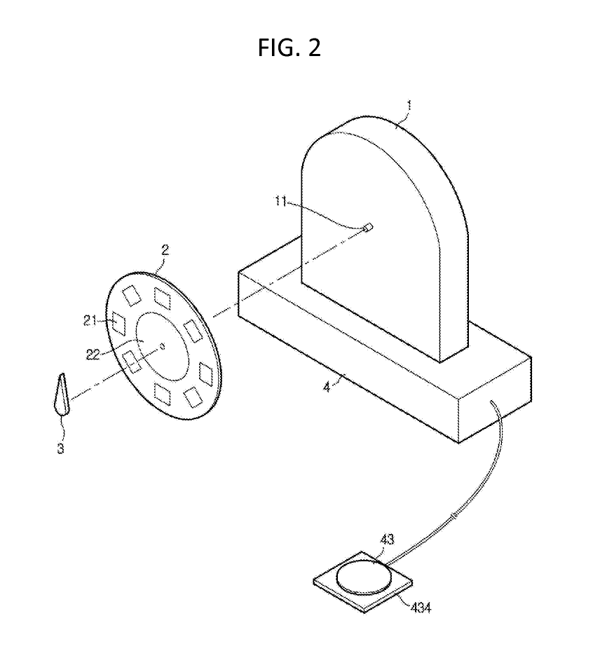

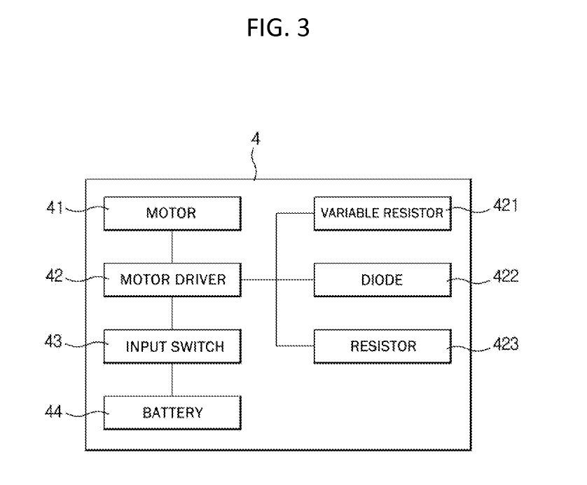

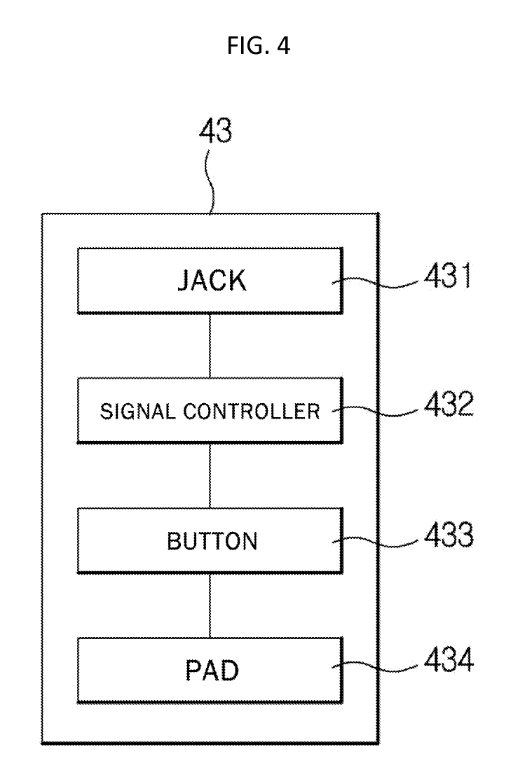

FIG. 1 is a perspective view of an augmentative and alternative communication (AAC) device for a disabled person according to an embodiment of the present invention. FIG. 2 is a perspective view with separate parts of the AAC for the disabled person according to an embodiment of the present invention. FIG. 3 is a structural view of a controller 4 of the AAC for the disabled person according to an embodiment of the present invention. FIG. 4 is a structural view of an input switch 43 of the AAC for the disabled person according to an embodiment of the present invention.

As shown in FIGS. 1 through 4, the AAC for the disabled person according to an embodiment of the present invention includes a main body 1, a communication display board 2, an indicator 3, and the controller 4.

The main body 1 may be made from a transparent resin material and has a general board shape, further characterized by a circular or angular form, in which an indicator connector 11 protrudes from a front center portion.

The communication display board 2 is attached to a front surface of the main body 1, includes a plurality symbols 21 attached in a radial shape, and may be formed from a transparent film material. The communication display board 2 is attached to the main body 1 by compressing a film via annealing.

The communication display board 2 further includes a transparent blank 22 in the remaining portions, excluding a portion to which the symbols 21 are attached, so that additional symbols 21 may be attached.

More specifically, when the number of symbols 21 needs to be increased, a board to which additional symbols 21 are attached is attached to the transparent blank 22 of the communication display board 2, so that additional symbols 21 may be used.

The symbols 21 are used to assist people who have difficulty communicating with others. Targets of the symbols 21 include one of several places, things, activities, quantities, foods, persons, times, and characters.

The indicator 3 is rotatably connected to the indicator connector 11 to indicate the corresponding symbols 21 according to a user indication, and rotates in a clockwise or counter-clockwise direction according to a forward (viz., clockwise) or backward (viz., counter-clockwise) signal received from a jack 431 that is connected to a motor 41 of the controller 4 and the input switch 43 to indicate the corresponding symbols 21.

The indicator 3 may be manifested as various characters, animal forms, or as an LED to increase user concentration.

In one embodiment, the present invention may apply a boozer or a voice output function so that individuals with intellectual impairment may be cognitive for whether the indicator 3 operates during the operation of the indicator 3. The boozer or voice output function may be designed to be controlled by the controller 4.

The controller 4 is installed on a lower portion of the main body 1, receives an input signal from the user, and controls the operation of the indicator 3.

The controller 4 includes the motor 41 rotating and reversely rotating to revolve the indicator 3, a motor driver 42 applying a driving signal to the motor 41 to drive the motor 41, the input switch 43 inputting a signal for driving the motor 41, and a battery 44 supplying power to the motor driver 42.

The input switch 43 includes the jack 431 connected to the motor driver 42, a signal controller 432 connected to the jack 431 to detect a user click signal and control the click signal, a button 433 detecting a user click motion and delivering the click motion to the signal controller 432, and a pad 434 to which the signal controller 432 and the button 433 are fixedly attached.

In one embodiment, the present invention applies a wired input method of inputting a signal through the input switch 43. The present invention is not limited thereto and may apply a wireless input method using RFID and infrared rays.

The motor driver 42 includes a variable resistor 421 adjusting the intensity of a current to adjust a rotation speed of the motor 41, a diode 422 preventing a voltage equal to or higher than a predetermined voltage from being supplied, and a resistor 423 uniformly maintaining the current intensity of the diode 422.

The operation of the AAC for the disabled person, according to an embodiment of the present invention, will now be described below.

The user sees the communication display board 2 to determine a location of the corresponding symbol 21 to express the user's communication.

If the symbol 21 is turned in a clockwise or counter-clockwise direction through the input switch 43, current flows through the diode 422 and the resistor 423 through the motor driver 42 connected to the jack 431 and the motor 41, the motor 41 rotates, and then the indicator 3 rotates. In this regard, if the input switch 43 is pressed, the symbol 21 is turned on, and if the input switch 43 is not pressed, the symbol 21 is turned off.

The indicator 3 automatically stops at the next symbol 21 when the input switch 43 is pressed once, and stops at the next symbol 21 if the input switch 43 is pressed again.

When the indicator 3 is placed at a corresponding symbol 21 by the user, the other party can see the corresponding symbol 21 and determine the user's desired communication.

The AAC for the disabled person, according to an embodiment of the present invention, may help disabled persons enhance their physical abilities, cognitive skills, linguistic abilities, and learning abilities, as well as provide users with a more practical and diverse communication device with added convenience and accessibility.

The AAC device, according to the present invention, is configured for using symbols, and thus the AAC device is more inexpensive than systematized devices. This symbol-based configuration reduces the economic burden of customers and, at the same time, increases the convenience for use and accessibility of disabled persons, thereby enhancing their physical abilities, cognitive skills, linguistic abilities, and learning abilities.

In addition, the AAC device has a simple structure unlike a complex system, thereby the use or management of the AAC device comes without having to learn the general knowledge of AAC.

While the invention has been particularly shown and described with reference to exemplary embodiments thereof, it will be understood by those of ordinary skill in the art that various changes in form and details may be made therein without departing from the spirit and scope of the invention as defined by the following claims.

1. An augmentative and alternative communication (AAC) device for a disabled person, the AAC device comprising:
a main body having a board shape in which an indicator connector protrudes from a front center portion;
a communication display board attached to a front surface of the main body and comprising a plurality symbols attached in a radial shape;
an indicator rotatably connected to the indicator connector to indicate the corresponding symbols according to a user indication; and
a controller installed on a lower portion of the main body, receiving an input signal from the user, and controlling the operation of the indicator.

2. The AAC device of claim 1, wherein the communication display board comprises a transparent blank in the remaining portions excluding a portion to which the plurality of symbols are attached.

3. The AAC device of claim 1, wherein targets of the plurality of symbols comprises one of places, things, activities, quantities, foods, persons, times, and characters.

4. The AAC device of claim 1, wherein the controller comprises:
a motor rotating and reversely rotating to revolve the indicator;
a motor driver applying a driving signal to the motor to drive the motor;
an input switch inputting a signal for driving the motor; and
a battery supplying power to the motor driver.

5. The AAC device of claim 4, wherein the input switch comprises:
a jack connected to the motor driver;
a signal controller connected to the jack to detect a user click signal and control the click signal;
a button detecting a user click motion and delivering the click motion to the signal controller; and
a pad to which the signal controller and the button are fixedly attached.

6. The AAC device of claim 2, wherein targets of the plurality of symbols comprises one of several places, things, activities, quantities, foods, persons, times, and characters.
